(19) United States
(12) Patent Application Publication
(10) Pub. No.: US 2009/0094090 A1
(43) Pub. Date: Apr. 9, 2009

(54) LEAN STAFFING METHODOLOGY

(76) Inventor: Scott Dow, Dallas, TX (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 11/867,861

(22) Filed: Oct. 5, 2007

(51) Int. Cl. G06F 17/30

(52) U.S. Cl. 705/9; 705/7

(57) ABSTRACT

A method of sourcing resumes from databases connected to the internet, the method comprising of receiving a requirement from an employer for one or more candidate(s) to be employed, assessing the requirement to obtain a desired profile of the candidate to be employed, defining at least one primary internet keyword search command based on the desired profile, collecting a first set of resumes based on the at least one primary internet keyword search command, mapping inputs provided by the employer, wherein the inputs are based on the first set of resumes collected, converting the inputs provided by the employer to at least one secondary internet keyword search command, collecting a second set of resumes based on the at least one secondary internet keyword search command, calibrating the candidates identified by the second set of resumes using the at least one secondary internet keyword search command, establishing a standard to identify candidates suitable for an interview, converting the established standard to atleast one final internet keyword search command, and sourcing resumes of candidates according to the at least one final internet search command.

### FIELD OF THE INVENTION

The invention relates in general to a method of hiring candidates, and, in particular to a method of sourcing resumes from databases connected to the Internet.

### DESCRIPTION OF THE PRIOR ART

The staffing industry is $100b+ industry comprised of headhunters, staffing companies and various forms of recruitment services. With the emergence of world wide web and technology infrastructure, many employment related websites have also come into existence. Many of these sites feature resume databases. Employers are becoming more and more reliant on resume databases as a source of recruitment. Workers are also more mobile now than ever before, and tend to change jobs much more frequently. Therefore, more resumes are being posted on-line, and more employers are using resume data bases as their primary source of candidates. As most of the employment agencies receive payment only for those positions which they fill with the qualified employee candidates, it becomes even more important to be able to select the best possible candidate for the position(s), advertised. With the numbers of such databases increasing on daily basis, it becomes a tedious task to source resumes that are best suited to the position and are up to the expectations of the Employer (or his hiring manager).

Hiring decisions are not based on any formal training and are not very consistent; a lot depends upon the perception of the hiring manager for the potential employee. Hiring managers invariably inflict psychological complexity to the staffing process. For assuring predictability of selection of a candidate it is thus essential to understand the Hiring manager's view for the candidate.

Some common methods employed for selecting the candidates from the database include manual matching of job requirements and resume data by some trained persons. This is a very time consuming process which gets only a limited number of results. The probability for selection of such candidates cannot be easily gauged.

Some automated methods of research use a few keywords based on the criteria set in the candidate profile issued by the recruiting manager. This process leaves the recruiter with a huge number of results, which need to be manually examined and confirmed for further processing. The probability for selection of such candidates cannot be assessed because of the uncertainty in the perception of the suitable candidate as assessed by the hiring Manager.

Some other methods involve formation of unique database containing various types of information on the candidate profile like level of skill, skills set possessed, intelligence quotient, etc. However, the said information does not provide us with a mass sourcing solution as this lacks universal applicability.

U.S. Pat. No. 7,080,057 and U.S. Patent application 20020042786 disclose a method to automate the job application and employee selection process through the use of an artificial-intelligence technique, wherein post hire and pre hire information on the selected candidates is recorded and assessed to prepare and/or amend a test/questionnaire for future candidates. The job performance criterion e.g., tenure, number of accidents, sales level, or the like is assessed on the basis of previous employee data. Outcomes of the interview are predicted for any of a wide variety of parameters. This process neither defines the desired candidate profile nor any narrowing option from a large variety of resumes, but only from a selected set.

U.S. Pat. No. 7,219,066 discloses a Web-based Requisition/Catalog (REQ/CAT) web application tool, called the Skills Matching Application (SMA) which allows a user, such as a hiring manager, to communicate requirements to technical service suppliers in a way that reduces the process time and improves the accuracy of requests sent to suppliers. The method applied here includes entering of complete skill, level of skill, work location and other such criteria by the hiring manager, on prompts through a series of screens laid out and later giving indicative priority to various factors. This process helps in conveying the employee data to the recruitment agencies, but does not provide a method of providing/sourcing candidates for interview.

U.S. Pat. No. 6,735,570 and U.S. Pat. No. 5,918,207 disclose aids to administration in skill assessment of the workers by using wide variety of skills as indicators for assessment of user's proficiency at performing the skills in the skill set. The administration can use this data to formulate teams of candidates for any particular kind of tasks like skill planning, where the person needs to develop the skills set for increasing the chances of selection. This process does not provide for any candidate sourcing solution.

U.S. Pat. No. 7,162,432 discloses a computer implemented system for assessing and creating a classification significance pattern for expressing a preference with respect to various products, job preferences, tastes, recreation or travel, life satisfaction, etc. by having a user take a psychological test. This test is further conveyed to various companies and advertising agencies to establish potential targets for various products and services. This process does not address the suitability criteria of the required candidate profile nor suggest the success predictability of the candidate.

U.S. Pat. No. 5,551,880 discloses a system for predicting potential of success of an individual for a particular task. Behavioral and values information is derived from the individual. This information is then analyzed and compared against standards for behavior and values previously calculated for the specific job. An evaluation can then be made of the applicant's responses to the standards to predict success of a perspective employee for the particular job. This process provides the suitability criteria of the candidate for the job but not the predictability of success of the candidate in the interview.

U.S. Pat. No. 7,143,066 discloses a matching, narrowcasting, classifying and/or selecting process for people and/or things as per pre-existing classification schemes. The schemes may include at least some rights management information together with any artificial intelligence, statistical, computational, manual, or any other means to define new classes, class hierarchies, classification systems, category schemes, and/or assign persons, things, and/or groups of persons and/or things to at least one class. The system thus helps in bunching the prospective candidates on certain set criteria and not the actual calculated method of sourcing candidates for interview.

U.S. Pat. No. 6,742,002, WO/2006/110778, WO/2005/114377 & WO/2001/061611 disclose various staffing solutions which include fixing candidates for interview, but none of the processes can guarantee or give a reasonable probability of selection of the sourced candidate.

From the discussion above, it is clear that there is a distinct need for associating Hiring Manager's perception of the candidate to the final candidate profile for gaining predictability in selection of the candidate and sourcing the candidates accordingly. The problem in searching on-line resume data bases is not the lack of resumes but the overabundance of resumes. Resumes are easy to download and present to managers interested in hiring. The problem is finding the resumes that are most appealing to the manager. Also a need is that the process be easily applicable to all types of job search databases. There is a need for an online psychological patterning system that enables the recruiter to search and screen the candidates based upon the predisposed profile of the candidate imprinted in the mind of the hiring manager.

### OBJECTS AND SUMMARY OF THE INVENTION

A method of sourcing resumes from databases connected to the internet, the method comprising of receiving a requirement from an employer for one or more candidates to be employed, assessing the requirement to obtain a desired profile of one or more candidates to be employed, defining at least one primary internet keyword search command based on the desired profile, collecting a first set of resumes based on the at least one primary internet keyword search command, mapping inputs provided by the employer, wherein the inputs are based on the first set of resumes collected, converting the inputs provided by the employer to at least one secondary internet keyword search command, collecting a second set of resumes based on the at least one secondary internet keyword search command, calibrating the candidates identified by the second set of resumes using the at least one secondary internet keyword search command, establishing a standard to identify candidates suitable for an interview, converting the established standard to atleast one final internet keyword search command, and sourcing resumes of candidates according to the at least one final internet search command.

### BRIEF DESCRIPTION OF THE DRAWINGS

The invention will be better understood by reference to the following drawings in which:

FIGS. 1A & 1B is a flowchart diagram of overall screening and assessment interview process of the present invention.

FIG. 2 is a flowchart diagram of n*n process.

FIG. 3 is a flowchart diagram of the mental mapping process of the Manager.

### DETAILED DESCRIPTION OF THE INVENTION

Various processes are described with reference to the flowcharts, wherein like reference numerals are used to refer to like elements throughout. In the following description, for purposes of explanation, numerous specific details are set forth in order to provide a thorough understanding of one or more processes. It may be evident, however, that such processes may be practiced without these specific details.

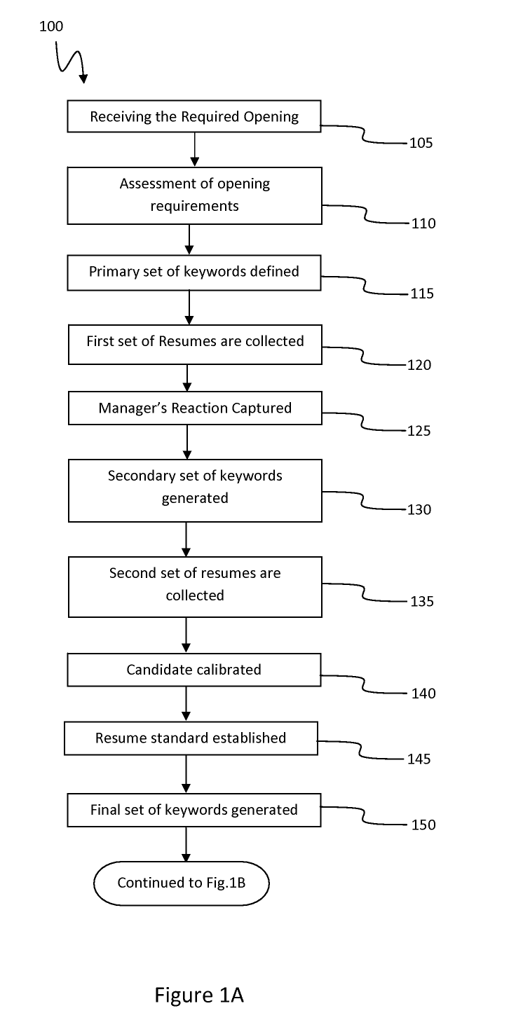

FIGS. 1A & 1B illustrate an overall screening and assessment interview process 100 according to the present invention. The process 100 includes, at 105, receiving a requirement of one or more candidates for a job opening. At 110, the desired candidate requirements are assessed for the opening. The step 110 also includes development and communication of Service Level Agreement to an employer explaining roles, and expectations of each party, viz., the employer, the employee and the recruiter (or sourcing agent). Any individual acting on behalf of the employer to interact with recruitment agencies, headhunters, staffing companies, or placement agencies and finally the candidate (for e.g., a recruitment manager) is well within the scope of the wording “employer”. At 115, at least one primary internet keyword search command is defined by the recruiter or the staffing company, based on ‘n’ examples in ‘n’ vital areas of sourcing and selection for the required job opening provided by the employer. At 120, a first set of resumes are collected, based on the at least one primary internet keyword search command as defined at 115. The first set of resumes is collected in such a way so as to vary the critical factors in the resumes. The resume set is then presented to the employer and his inputs on the resumes are captured and then mapped at 125.

The psychological/mental maps are uncovered using the study of cognitive behavioral psychology. The fundamental assumption underlying this type of psychometric analysis is that the human mind is a complex psychological system whose attributes can be reliably measured. A second assumption is that these attributes influence human behavior. It has been proven that human beliefs are rarely consciously explored. They unconsciously jump to the same old conclusions time and time again. Therefore, it can be easily summarized as:

“Untested, unconscious, self generating beliefs+opaqueness=significant complexity”

The complexity in this type of analysis is the fact that the mental map followed by most employers/hiring managers is invisible. Only the beginning (job descriptions, resumes) and the end result (interview or not, hire or not) are observed. The abstract nature of meaning, assumptions, conclusions and beliefs are never readily apparent.

Accordingly, the mapping of inputs of the employer in accordance with the present invention comprises uncovering mental hiring predispositions of the employer through the use of cognitive behavioral psychology based on the forces of reflection, communication and collaboration. A sample mental map for employer can be summarized as follows:

Available Data—resume, past hiring experience, company tradition
Selecting data—“I look for 3-5 years of ERP software sales experience . . . ”
Meaning—“ . . . that means they have dealt with the capital planning process.”
Assumptions—“Capital planning requires complex financial business cases to be made . . . ”
Conclusions—“And if you can make a financial business case that requires multi-million dollar investments, you can sell our service.”
Beliefs—“These people make a much smoother transition AND require much less training.”
Actions—vetoes any candidate that does not have the 3-5 years of enterprise software sales experience and tends to hire people who do.

The reactions on various aspects as provided in the first set of resumes at 125 are noted by the recruiter as positive, negative or neutral. At 130, the inputs provided by the employer are converted to at least one secondary internet keyword search command which is further used in collecting a second set of resumes at 135. The critical factors in each profile are varied systematically. The candidate calibration at 140 is then undertaken with the employer to establish a standard of candidates at 145, suitable for an interview round. At 150, this established standard is converted into atleast one final internet keyword search command and, at 155, the sourced candidates are screened according to the updated/final internet search command. In case the candidate standard is not met at 190, the resume is rejected and the recruitment process for the candidate standard ends here. Where the candidate standard is met at 155, assessment of interest of the candidate and his/her availability is established at 160, through the means of phone screening or setting up a telephone call with the employer for scheduling the interview. At 165, the interview is conducted and the hiring decision is made. The selected candidate is offered the job at 180, and the recruitment process is closed at 185. In case the candidate is not selected, the candidate is disengaged at 170 and the recruitment process for the candidate is closed at 175.

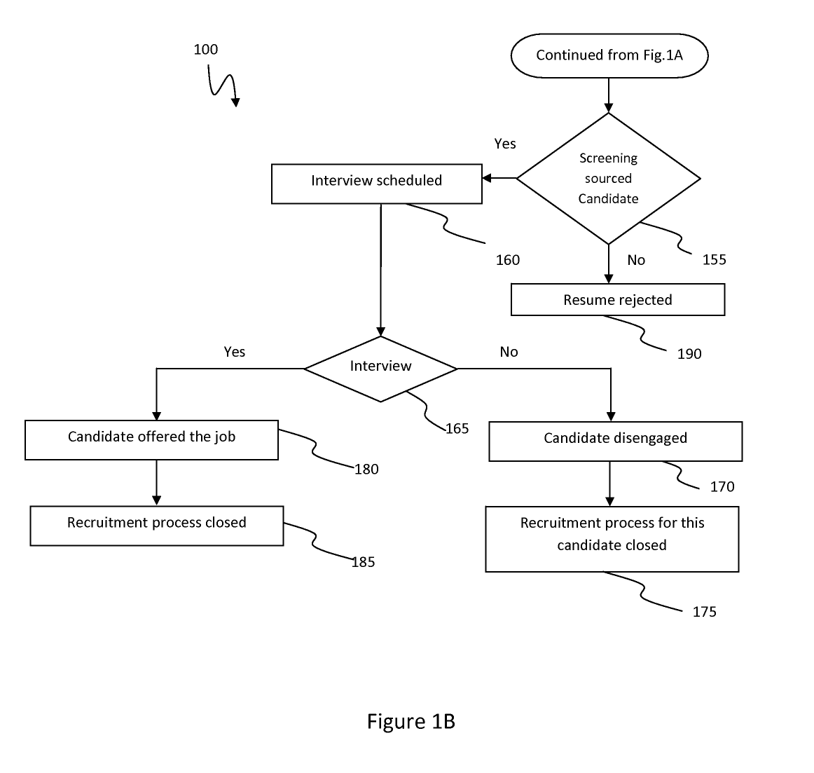

FIG. 2 illustrates the n*n process for generating the initial keyword search commands. The n*n process 200 includes receiving the requirement of candidate(s) for a job opening at 205. At 210, an assessment of the desired candidate profile on the basis of ‘n’ examples asked from the employer within ‘n’ vital areas of sourcing and selection process related to the particular job requirements is undertaken by the recruiter. These vital areas cover the basic job profile of the opening requirement. On the basis of inputs of the employer, a primary set of keywords are generated at 215.

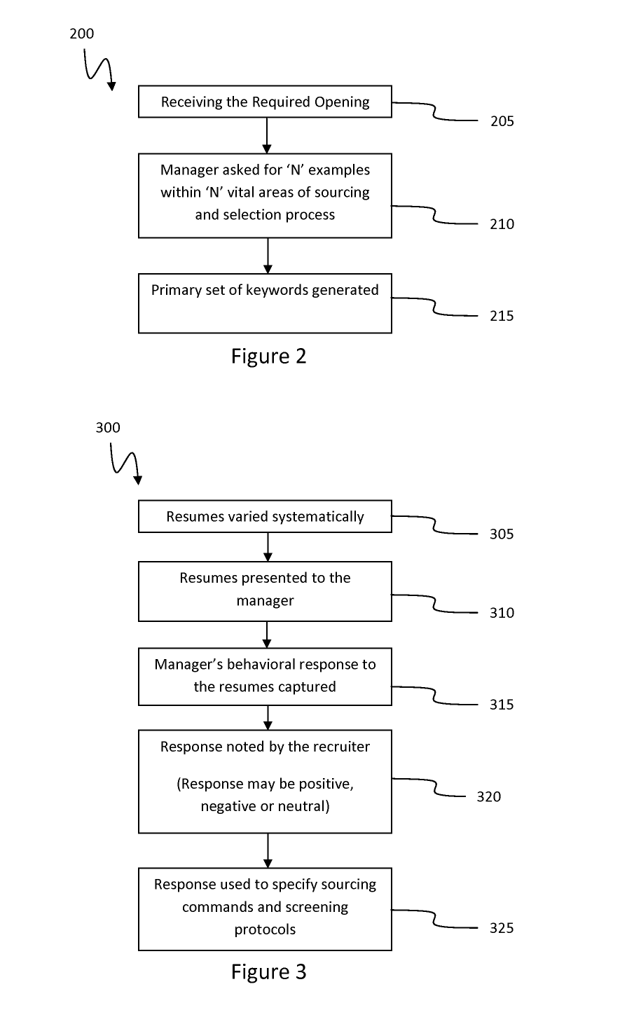

FIG. 3 illustrates the process of mental mapping of the employer 300 which includes mapping for details that include existence of interactions and synergies between candidates attributes. The process 300 includes systematically varying the critical elements in the resumes of the candidates at 305. The resume set is then presented to the employer at 310 and the behavioral response of the employer to each aspect is captured at 315 which are then noted by the recruiter at 320. The response is used to specify sourcing commands and screening protocols 325.

While this invention has been described in detail with reference to certain preferred procedures, it should be appreciated that the present invention is not limited to those precise processes. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. A method of sourcing resumes from databases connected to the internet, the method comprising:
receiving a requirement from an employer for one or more candidates to be employed;
assessing the requirement to obtain a desired profile of one or more candidates to be employed;
defining at least one primary internet keyword search command based on the desired profile;
collecting a first set of resumes based on the at least one primary internet keyword search command;
mapping inputs provided by the employer, wherein said inputs are based on the first set of resumes collected;
converting the inputs provided by the employer to at least one secondary internet keyword search command;
collecting a second set of resumes based on the at least one secondary internet keyword search command;
calibrating the candidates identified by the second set of resumes using the at least one secondary internet keyword search command;
establishing a standard to identify candidates suitable for an interview;
converting the established standard to atleast one final internet keyword search command; and
sourcing resumes of candidates according to the at least one final internet search command.

2. The method as set forth in claim 1, further comprising screening the resumes of candidates sourced in accordance with the established standard.

3. The method as set forth in claim 2, further comprising scheduling interviews for the candidates meeting the established standard.

4. The method as set forth in claim 3, further comprising providing an offer of employment to the candidate qualifying the interview.

5. The method as set forth in claim 1, wherein mapping inputs of the employer comprises uncovering mental hiring predispositions of the employer through the use of cognitive behavioral psychology.

6. The method as set forth in claim 5, wherein uncovering mental hiring predispositions of the employer comprises uncovering the mental map of the employer through the forces of reflection, communication and collaboration.

7. The method as set forth in claim 1, wherein mapping comprises mapping for details that include existence of interactions and synergies between candidates attributes.

8. The method as set forth in claim 1 wherein collecting the first and the second sets of resumes include collecting at least one resume having variation in terms of critical factors.
